(19) United States
(12) Patent Application Publication
(10) Pub. No.: US 2007/0061831 A1
(43) Pub. Date: Mar. 15, 2007

(54) IPTV channel usage and video delivery path monitoring architecture

(75) Inventors: Raghvendra G. Savoor, Walnut Creek, CA (US); Zhi Li, San Ramon, CA (US); David L. Kimble, Danville, CA (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/223,710

(22) Filed: Sep. 9, 2005

(51) Int. Cl. H04N 7/16; H04H 9/00; H04N 7/173

(52) U.S. Cl. 725/13; 725/105; 725/9

(57) ABSTRACT

In accordance with one aspect of the present invention, a method for monitoring usage of a channel, including monitoring upstream information, and determining usage of the channel in response to the monitoring is disclosed. In accordance with another aspect of the present invention, a service module for monitoring usage of a channel includes a data input operative to monitor upstream information, and a processor that determines usage of the channel in response to the data input is disclosed. In accordance with another aspect of present invention, the method and module also include monitoring video delivery path performance and detecting potential denial-of-service (DoS) attacks to video servers is disclosed.

### BACKGROUND OF THE INVENTION

1. Field of the Invention

The present invention relates to the field of media content distribution, and more specifically to the monitoring of channel usage and video delivery paths.

2. Description of the Related Art

Most of the current video contents, such as television (TV) programming, are provided by cable television TV service providers and satellite TV service providers. In such cases, TV video and audio contents for all channels are continuously transmitted to the subscribers or users. The users select the channels to watch utilizing a set-top-box (STB) and a remote control (RC) device. TV Networks or content providers, such as CNN, FOX, CBS, etc. make a large number of business decisions relating to which programs to provide and the timeslots for the various programs based on the information relating to the channel usage or ratings. Service providers, such as the assignee of this application, cable and satellite service providers also depend on the ratings to select which services they will provide. A traditional rating system for television programming, such as Nielsen-like TV rating system, requires the collaboration of subscribers and it only provides sampling results of limited information for the traditional TV services. Such rating systems are inherently imprecise, are not comprehensive and are delayed. In addition, there is inadequate information available to the service provider about the quality of the video content delivered to the subscribers, i.e. the quality of the video delivery paths.

Internet Protocol-based TV is an alternative way to provide TV programs and other video contents to the subscribers. IPTV can also provide videos-on-demand (VD) from Libraries of video contents that may include substantially an unlimited number of videos. Additionally, the inherent flexibilities on top of IP-based video service network can provide advanced and flexible services (such as picture-in-picture), high quality pictures (high-definition TV), and large amount of information (large number of TV channels). It is thus useful to have systems and methods that can provide comprehensive and on time information and about TV or video content usage information and about the video delivery path quality of service to the subscribers.

Monitoring of subscribers' channel tuning dynamics and viewing activities, such as the list of popular channels, channel changing frequencies, channel usage time periods, per-subscriber IPTV usage, content viewing information etc. are useful parameters for the service providers and the content providers. Such information is useful to improve customer service, advertising sales and relationships among the service and content providers. Also, IPTV is quality of service sensitive and thus monitoring of the video path performance is useful in determining the system network requirements, such a placement of servers, routers and other devices, troubleshooting of the system and for taking corrective actions.

The present invention addresses some of the above mentioned needs.

### SUMMARY OF THE INVENTION

In accordance with one aspect of the present invention, a method for monitoring usage of a channel, including monitoring upstream information, and determining usage of the channel in response to the monitoring is disclosed. In accordance with another aspect of the present invention, a service module for monitoring usage of a channel includes a data input operative to monitor upstream information, and a processor that determines usage of the channel in response to the data input is disclosed. In accordance with another aspect of present invention, the method and module also include monitoring video delivery path performance and detecting potential denial-of-service (DoS) attacks to video servers is disclosed.

Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE DRAWINGS

For detailed understanding of the present invention, references should be made to the following detailed description of various exemplary embodiments, each of which is presented by way of example and not by way of limitation, taken in conjunction with the accompanying drawings, in which like elements have been given like numerals.

FIG. 1 is a schematic diagram depicting an IPTV network in accordance with an embodiment of the present invention.

FIG. 2 is a flowchart depicting a method for monitoring channel usage and video delivery path performance, in accordance with an embodiment of the present invention.

FIG. 3 is a schematic diagram depicting a service module for monitoring channel usage and video delivery path performance, in accordance with another embodiment of the present invention.

### DETAILED DESCRIPTION OF THE INVENTION

In view of the above, the present invention through one or more of its various aspects and/or embodiments is presented to provide one or more advantages, such as those noted below.

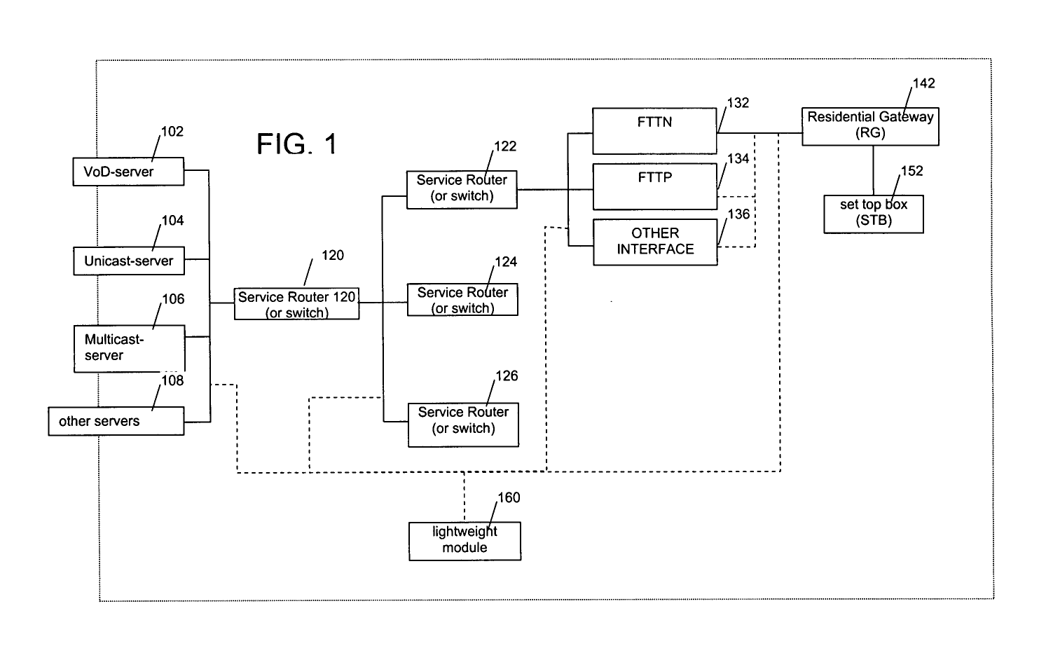

FIG. 1 is a schematic diagram depicting an exemplary IPTV network in accordance with an embodiment of the present invention. The IPTV network may include several servers, such as one or more VoD-servers 102, one or more Unicast-servers 104, and one or more Multicast-servers 106, as well as other servers 108. The IPTV network may implement a video compression algorithm, such as MPEG-2, MPEG-4, or any other suitable method or technique to deliver several types of frames, including but not limited to intraframe video content (“I”-frames), predicted frame content (“P”-frames), and bi-directional frame content (“B”-frames).

The Multicast-server 106 may store, for example, a large number of movies, music videos, video games, and other audio, video, graphics, television programming, made-for-television movies, advertisements, news images, and audio/video content, as well as other types of content. An Multicast-server 106 may be described as a “standard content” server, since its content may be provided to all consumers. The Multicast-server 106 may periodically provide an I-frame of a particular movie, for example, to the IPTV network, allowing all consumers to receive the I-frame. Each set top box (STB) of each consumer can receive the I-frame and can store the I-frame until a subsequent I-frame is received.

The VoD-server 106 may be utilized to provide services, such as video-on-demand (VOD). The VoD-server 102 may store a large number of movies, music videos, video games, and other audio, video, graphics, and audio/video content, as well as other types of content. Thus, the VoD-server 102 may be described as a Video-On-Demand (VoD) server, since its content may be provided to consumers for a charge. The V-servers 102 may periodically provide an I-frame of a VoD movie, for example, to the IPTV network, allowing all consumers who have paid for the VoD movie to receive the I-frame. Each set top box (STB) of each consumer who has paid for the VoD movie can receive the I-frame and can store the I-frame until a subsequent I-frame is received.

To preserve bandwidth, the V-server 102 may provide P-frames and B-frames between I-frames, allowing each STB of each consumer who has paid for the VoD movie to modify the most recently received I-frame for presentation on the display device coupled to the STB. Since many pixels on the display device may remain constant from one frame to a subsequent frame, updating the I-frame with P-frames and B-frames may be more efficient than sending a subsequent I-frame.

Other servers 108 may also be included, and may provide any of a variety of content. The other servers 108 may provide additional services, as well. As each of the other servers 108 provides frames to the IPTV network, the Unicast-server 104 may store a copy of each frame and provide a retransmission of each frame to each STB that requests a retransmission, without requiring any of the other servers 108 to provide the retransmission.

It will be appreciated that, although the Multicast-server 106, the VoD-server 102, the Unicast-server 104, and the other servers 108 are described herein as servers, each may be implemented as a colocated or distributed server cluster, including discrete server farms, firewalls, and control systems. Also, more than one server or type of server may be implemented on a single machine, and any machine may implement many servers or portions of many servers, in hardware, in software, or in both hardware and software.

The Multicast-server 106, the VoD-server 102, the D-server 104, and the other servers 108 may be coupled to one another and to a collection of STBs via the IPTV network, which may also include other devices. For example, the IPTV network may include several Service Routers, including a Service Router or switch 120. Each Service Router 120 can include both hardware and software to couple the Multicast-server 106, the VoD-server 102, the Unicast-server 104, and the other servers 108 to a plurality of switches.

Fiber to the Node (FTTN) 132, Fiber TO the Premise (FTTP) 134, or any other suitable interface 136 may be coupled via a Residential Gateway (RG) 142 to a set top box (STB) 152, which may be coupled (via wirelines or via wireless connections, such as Bluetooth) to one or more display devices, such as television sets, computers, and other electronic consumer devices. The FTTN/FTTP interfaces provide links from the service routers to the end users or subscribers. The STB 152 may contain a memory that stores a video frame, and may display the video frame on the display device, in response to receiving the video frame from the IPTV network. The I-frame may be received, for example, at intervals. An exemplary interval may be approximately ten seconds, although each I-frame need not be received at precisely timed intervals. In response to a P-frame or a B-frame, the STB 152 may display an image that is a function of the P-frame or the B-frame and the I-frame in memory

From time to time, the STB 152 may send signals to the Unicast-server 104 via the IPTV network. Specifically, the STB 152 may send requests for retransmission of packets, and may also send requests for video frames after channel changes. If errors occur in the “downstream” transmission of packets from the servers (i.e., the Multicast-server 106, the VoD-server 102, the Unicast-server 104, and the other servers 108), then the STB 152 may send requests for retransmission of packets. The requests sent from any STB 152 may be described as “upstream” packets. The Unicast-server 104 services the retransmission of the packets, even if the packet for which retransmission is sought originated in the Multicast-server 106, the VoD-server 102, or any of the other servers 108. The term “downstream transmission” is used to mean information transmitted toward end users and the term “upstream information” is used to mean information transmitted toward the servers. The terms “packet” or “packets” is used in a general server and may include signals, data, control signals and the like.

Similarly, if a consumer changes channels to a channel for which the STB 152 does not have video frames in short time, the STB 152 may request short-time video frames pertaining to the desired channel from the Unicast-server 104. For example, if a consumer changes channels to a new channel transmitted from a source server (i.e., a Multicast-server 106, a VoD-server 102, or any of the other servers 108) that has just provided an I-frame, another I-frame may not be available for several seconds. Accordingly, the STB 152 may request an I-frame, and the Unicast-server 104 may provide the I-frame in response to the request from the STB 152. The STB 152 may then provide images to the display device using the I-frame from the Unicast-server 104.

A module 160, also referred to herein as a service module or a lightweight module, may be coupled to the IPTV network. The module 160 may be coupled at any suitable location in the network, either through a wire line connection, a wireless connection, or a combination of wireless and wire line connections. The module 160 may be implemented in hardware, in software, in firmware, or in a combination of hardware, software, and/or firmware, and may be implemented in a single machine or in a cluster of machines, either collocated or distributed.

The module 160 may be operative to monitor the upstream packets to video servers and to perform analysis. The requests for retransmission issued by STBs to a Unicast-server 104 may allow the module 160 to estimate line quality of the IPTV network, and to generate a report that may be useful in planning infrastructure upgrades, maintenance, and repairs. If the retransmission requests are tagged with STB location information, or if the retransmission requests are tagged with STB identifier information and the module 160 is able to determine STB location from the STB identifier information, then the module 160 may be able to generate a report that can indicate where, geographically, repair and maintenance efforts should be directed.

The module 160 may also be operative to monitor requests for some video frames after channel changes. Thus, the module 160 may be able to determine which television channel the consumer is watching. Determining which television channel each consumer is watching may be useful to determining ratings for a particular television channel and for each particular movie, which may be important to advertisers and to other demographers. For example, even merchants who do not advertise on television may be interested in knowing what interests a particular consumer has. Television viewing habits of nearly every consumer household may thus be monitored individually and substantially in real time, generating information that may even be more valuable than Nielsen ratings.

The module 160 may also be operative to query each STB for limited times. Whenever the module 160 detects a request for retransmission of a packet or a request for some video frames after channel changes. The module 160 then may be able to determine which channel the STB that has generated the request for retransmission of a packet or a request for video frames that the channel is presenting. However, if the module 160 determines that a particular STB has neither requested retransmission of a packet nor requested video frames during the predetermined period of time, the module 160 may query the STB. In accordance with one embodiment of the present invention, the module 160 may broadcast the query to all STBs on the IPTV network collectively and synchronously. The query itself may indicate a period of time. Each STB that has neither requested a retransmission of a packet nor requested any video frame during the period of time may provide its STB identifier in response to the query.

In accordance with another embodiment of the present invention, the module 160 may query each STB individually. The module 160 may include a memory that maintains a list of all STBs in the IPTV network, and a timestamp of a most recent upstream packet corresponding to each STB. The module 160 may issue an addressed query to each STB that has not provided an upstream packet during a predetermined period of time. Each STB may respond either by providing an STB identifier or by requesting a video frame packet. Each STB may respond immediately to the query, or may wait a predetermined amount of time in accordance with its STB identifier (to reduce a likelihood of collisions), or may wait a random amount of time before responding (also to reduce a likelihood of collisions). Each STB may also simply introduce a packet containing its STB identifier into the Internet, to be detected by the module 160.

In accordance with yet another embodiment of the present invention, the module 160 need not generate a query, since each STB may be programmed to generate an upstream packet spontaneously whenever a predetermined period of time has elapsed since it most recently generated an upstream packet. The upstream packet may include an STB identifier and either a channel identifier or a content identifier, such that the module 160 may determine what the consumer is watching.

Whenever the consumer turns off the STB, the upstream packets terminate. The STB does not provide any upstream packets, even in response to a query from the module 160. Accordingly, the module 160 may determine how long the consumer watched the television, at the television channel indicated by a last upstream packet.

The module 160 may also determine whether a particular STB has been co-opted by a hacker. If a hacker hoping to implement a Denial-of-Service (DoS) attack manages to introduce zombies onto a group of STBs such that the group of STBs is programmed to overload a particular server at a particular time, the module 160 may be able to detect a large number of similar or identical upstream packets. If an excessive number of upstream packets request a particular channel at a particular time, the module 160 may filter out the upstream packets to protect a source server operative to deliver the particular channel.

Thus, with little involvement of clients, accurate subscribers' video usage information can be retrieved in real time. By monitoring the packet recovery requests sent to Unicast-server, the module 160 can estimate each subscriber's service path performance and pinpoint the potential path problem. By tracing the packets to Unicast-Server or VoD-Server, the module 160 can detect or trace back the potential or ongoing flood-based denial of service attacks to video services. The placement of the proposed service module is flexible.

For IPTV service providers, monitoring subscribers' channel tuning dynamics and Video on Demand (VoD) viewing activities; such as the list of popular channels, channel changing frequencies and time, per-household IPTV usage, content viewing information, can be useful. Monitoring subscriber activity events can enable service providers to gain a better understanding of the services and features subscribers are using. This information is useful to improve customer marketing campaigns, advertising sales, and relationships with networks. At the same time, IPTV is an extreme QoS-sensitive (quality-of-service sensitive) application. Monitoring video delivery path performance is also very critical for troubleshooting, placement of Unicast-Servers, and other technical issues.

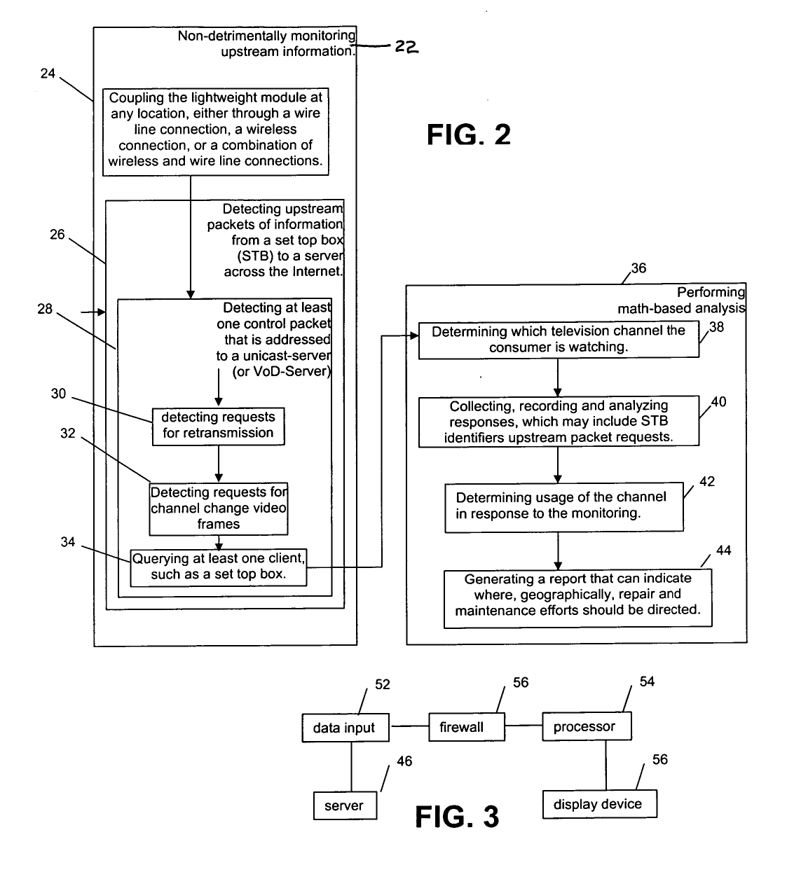

FIG. 2 is a flowchart depicting a method for monitoring usage of a channel in accordance with an embodiment of the present invention. The method of FIG. 2 may include non-detrimentally or passively monitoring upstream information 22. The method may include, for example, coupling a module to an IPTV network such that the module 160 may detect, record and analyze upstream information (also known as control signals or upstream packets) from a large number of set top boxes to a video server, which, as noted above, may be implemented as one or more server clusters or one or more server farms. The method of FIG. 2 may also include determining usage of the channel in response to the monitoring.

If the module includes a hardware component, then the non-detrimental monitoring of upstream information 22 may include, for example, coupling the module at any location 24, either through a wire line connection, a wireless connection, or a combination of wireless and wire line connections. If the module includes a software component, then the software component may be implemented in one or more dedicated machines or may be distributed among several machines which may be single-purpose or dual purpose.

The non-detrimental monitoring of upstream information 22 may include detecting 26 upstream packets of information from a set top box (STB) to a server across the Internet. The upstream packets may describe each subscriber's channel tuning dynamics, video on demand (VoD) viewing activity, a list of at least one popular channel, a channel changing frequency, a channel changing time, a household-specific IPTV usage, content viewing information, and/or other information.

The detecting 26 upstream packets may include detecting 28 at least one control packet that is addressed to a Unicast-server. For example, the detecting 26 may include detecting requests for retransmission 30, detecting requests for I-frames 32, and querying at least one client, such as a set top box 32.

Detecting requests for retransmission 30 may allow the module to estimate line quality of the IPTV network, and to generate a report that may be useful in planning infrastructure upgrades, maintenance, and repairs. If the upstream packets are tagged with STB location information, or if the upstream packets are tagged with STB identifier information and the module is able to determine STB location from the STB identifier information, then the detecting requests for retransmission 30 may allow for the generating of a report that can indicate where, geographically, repair and maintenance efforts should be directed.

Detecting requests for short-time video frames, like detecting request for retransmission 30, may also allow for the generating of a report that can indicate which channel the subscriber is watching, or which channel the STB is playing. Since an STB generally does not request short-time video frames for a particular movie or other content unless a consumer is watching a television channel that is broadcasting the particular movie, the determining which television channel the consumer is watching may be possible. Determining which television channel each consumer is watching may be useful to determining or estimating usage or ratings for a particular television channel and for each particular movie, which may be important to advertisers and to other demographers. For example, even merchants who do not advertise on television may be interested in knowing the interests of a particular consumer. Television viewing habits of nearly every consumer household may thus be monitored individually, generating information that may even be more valuable than Nielsen ratings.

The detecting 26 upstream packets may include querying each STB 34. For example, if the module determines that a particular STB has neither requested retransmission of a packet nor requested short-time video frames during the predetermined period of time, querying the STB 34 may be appropriate. In accordance with one embodiment of the present invention, the querying of the STB 34 may include broadcasting the query to all STBs on the IPTV network collectively and synchronously. The query itself may indicate a period of time, and awaiting and collecting any responses from the STBs, such as STB identifiers in response to the query.

In accordance with another embodiment of the present invention, the querying of the STB 34 may include querying each STB individually. The querying of the STB 34 may include accessing a memory that maintains both a list of all STBs in the IPTV network and a timestamp of a most recent upstream packet corresponding to each STB and issuing an addressed query to each STB that has not provided an upstream packet during a predetermined period of time. The querying of the STB 34 may allow for the collecting, recording and analyzing responses, which may include STB identifiers upstream packet requests. The querying of the STB 34 may also including awaiting a predetermined amount of time in accordance with its STB identifier (to reduce a likelihood of collisions) or a random amount of time before responding (also to reduce a likelihood of collisions).

In accordance with yet another embodiment of the present invention, the querying of the STB 34 may be performed passively, i.e. the querying may be accomplished simply by awaiting, collecting and analyzing spontaneously introduced packets containing STB identifiers. For example, if each STB may be programmed to generate an upstream packet spontaneously whenever a predetermined period of time has elapsed since it most recently generated an upstream packet, then the querying may be performed passively by the module. The upstream packet may include an STB identifier and either a channel identifier or a content identifier, such that the module may determine what the consumer is watching.

The querying the STBs 34 may also include detecting an “STB-off” indicator, such as an STB-off packet received by the module in response to the querying or a non-responsiveness of an STB in response to the querying. Whenever the consumer turns off the STB, the upstream packets terminate. The STB may not provide any upstream packets, even in response to a query from the module.

A math-based analysis may be performed 36 in real time on the upstream packets. The math-based analysis may be executed by a processor at any location within the IPTV network, including at one or more servers and/or at one or more set top boxes. The math-based analysis may also be performed offline. The math-based analysis may include determining which television channel each subscriber is watching 38; collecting, recording and analyzing responses, which may include STB identifiers upstream packet requests 40; determining usage of the channel in response to the monitoring (that is, determining how many subscribers are watching each channel, for how long, and at what times of day); and generating a report that can indicate where, geographically, repair and maintenance efforts should be directed 44.

The math-based analysis may have an estimation accuracy and a probing interval, but may nevertheless be much more accurate than Nielsen ratings and other ratings systems. Moreover, the math-based analysis may provide one or more reports 44, that are available in real time, and that are easily transmitted electronically. The math-based analysis may include determining how long the consumer watched the television. The math-based analysis may also include 40 determining the television channel indicated by a last upstream packet. report that may be useful in planning infrastructure upgrades, maintenance, and repairs. The reports that may be generated may be helpful in determining where, geographically, repair and maintenance efforts should be directed, and thus may be useful in planning infrastructure upgrades, maintenance, and repairs. The reports may also be useful in generating ratings, on a household-by-household basis, since the reports may indicate which channel the subscriber is watching, or which channel the STB is playing. The reports may be communicated electronically, and subsequent processing may be performed on the reports, either within the IPTV network, within a computer system operated by an advertising agency or marketing company, or elsewhere.

The math-based analysis 36 may also include determining whether a particular STB has been co-opted by a hacker, e.g. as part of a Denial-of-Service (DoS) attack. The math-based analysis 32 may include detecting a large number of similar or identical upstream packets, and canceling the upstream packets to protect a source server operative to deliver the particular channel if an excessive number of upstream packets request a particular channel at a particular time. Thus, the non-detrimental monitoring of upstream information 22 may also include guarding against a denial of service (DoS) attack.

FIG. 3 is a schematic diagram depicting a service module for monitoring usage of a channel, in accordance with another embodiment of the present invention. The service module of FIG. 3 may include a data input 52 that can monitor upstream information; and a processor 54 that can determine the channel in response to the data input.

The data input 52 may non-detrimentally monitor at least one packet of information, such as a subscriber upstream packet, from a display device 58 to a server 46 across the internet. The subscriber upstream packet may be useful for describing subscriber channel tuning dynamics, video on demand viewing activity, a list of at least one popular channel, a channel changing frequency, a channel changing time, a household-specific IPTV usage, content viewing information, and/or other information. The data input 52 may also be useful to detect at least one control packet that is addressed to a VoD-server. The data input 52 may also query at least one client, such as a set top box. A firewall 56 may be used to protect the data input 52 against a denial of service (DoS) attack. The service module may also include the processor 54 that can perform a math-based analysis having an estimation accuracy and a probing interval.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims. Although certain types of servers have been shown and described, the present invention may instead utilize any suitable server, cluster of servers, or any other suitable machine.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

What is claimed is:

1. A method for determining usage of a channel, comprising:
monitoring upstream information; and
determining the usage of a channel in response to the monitoring of the upstream information.

2. The method for determining usage of a channel of claim 1, wherein:
monitoring the upstream information includes non-detrimentally monitoring packets of information from a device to a server over the internet.

3. The method for determining usage of a channel of claim 1, wherein:
the upstream information includes packets including a subscriber upstream packet operative to describe at least one of: a subscriber channel tuning dynamic, a video on demand viewing activity, a list of at least one popular channel, a channel changing frequency, a channel changing time, a household-specific IPTV usage, and content viewing information.

4. The method for determining usage of a channel of claim 1, wherein:
monitoring includes detecting at least one control packet that is addressed to a video-server.

5. The method for determining usage of a channel of claim 1, wherein:
monitoring includes querying at least one subscriber device.

6. The method for determining usage of a channel of claim 1, wherein:
determining includes performance of a math-based analysis having an estimation accuracy and a probing interval.

7. A method for determining video delivery path performance, comprising:
detecting upstream information indicative of a loss of packets;
determining from the detected upstream information the video delivery path performance.

8. The method for determining video deliver path performance of claim 7 further comprising determining denial of service (DoS) attacks to a server.

9. A service module, comprising:
a data input operative to monitor upstream information, the data input being further operative to non-detrimentally monitor at least one packet of information from a user-associated device to a server over the internet.

10. The service module of claim 9 further comprising a processor that determines one of (i) video delivery path performance, (ii) denial of service, and (iii) channel usage.

11. The service module of claim 9, wherein:
the data input is further operative to non-detrimentally monitor at least one packet of information from a user-associated device to a server over the internet.

12. The service module of claim 11, wherein:
the data input is further operative to monitor at least one subscriber upstream packet operative to describe at least one of: a subscriber channel tuning dynamic, a video on demand viewing activity, a list of at least one popular channel, a channel changing frequency, a channel changing time, a household-specific IPTV usage, and content viewing information.

13. The service module of claim 9, wherein:
the data input is further operative to query at least one client.

14. The service module of claim 9, further comprising:
a processor operative to perform a math-based analysis having an estimation accuracy and a probing interval.

15. A computer readable medium having a set of instructions operative to cause a computer to execute a method, the method comprising:
detecting upstream information sent from a device associated with a subscriber over an internet; and
determining from the detected upstream a parameter relating to delivery of an information over the internet to the subscriber.

16. The computer readable medium of claim 15 wherein the parameter is selected from a group consisting of (i) a subscriber channel tuning dynamic, (ii) a video on demand viewing activity, (iii) a channel changing activity, (iv) a channel changing time, (v) a channel usage, (vi) a user-specific IPTV usage, (vii) rating of a plurality of channels, (viii) quality of service, (ix) a denial of service, and (x) peak times for IPTV usage.

17. The computer readable medium of claim 15 further comprising sending a query to the device associated with the subscriber.

18. The computer readable medium of claim 15 wherein the device associated with the subscriber is one of (i) a set-top-box and (ii) an FTTN device.

19. A system for monitoring a network that provides video contents to a plurality of end users, wherein the network includes an end user device associated with each end user in the plurality of end users, and at least one server that receives an upstream information from the end user associated device over the internet, comprising:
an interface between each end user associated device and the server that detects upstream information sent by the each end user device and determines from the detected signals a parameter relating to the video contents.

20. The system of claim 19 wherein the interface includes a program that passively detects the upstream information.

21. The system of claim 19 wherein the interface further determines when the detected upstream information is outside a predetermined level and sends packets to the server that indicate an unacceptable service level.

22. The system of claim 19 wherein the parameter is one of: (i) channel usage by at least one of the end users, (ii) duration of use of channels by at least one of the end users, (iii) a level of video content delivery path performance that is below a predetermined level, and (iv) potential denial-of-service (DoS) attacks to video servers.
